(19) United States
(12) Patent Application Publication
(10) Pub. No.: US 2025/0271041 A1
(43) Pub. Date: Aug. 28, 2025

(54) ELECTROMECHANICAL BRAKE

(71) Applicant: Robert Bosch GmbH, Stuttgart (DE)

(72) Inventors: Mark Boehm, Lehrensteinsfeld (DE); Andreas Kaub, Moeglingen (DE); Christoph Oehler, Karlsruhe (DE); Martin Winkler, Sonthofen (DE); Martin Uhlig, Ilsfeld (DE); Thomas Diestmann, Ludwigsburg (DE)

(21) Appl. No.: 19/058,477

(22) Filed: Feb. 20, 2025

(30) Foreign Application Priority Data
Feb. 26, 2024 (DE) 10 2024 201 722.1

(51) Int. Cl. F16D 65/18; F16D 121/24; F16D 125/36; F16D 125/40; F16D 125/50; F16D 125/52; F16D 131/00

(52) U.S. Cl. CPC F16D 65/18; F16D 2121/24; F16D 2125/36; F16D 2125/40; F16D 2125/50; F16D 2125/52; F16D 2131/00

(57) ABSTRACT

An electromechanical brake for a motor vehicle. The electromechanical brake has a modular design, and a first module variant includes a brake clamp and a brake caliper housing connected to the brake clamp, in which housing a spindle drive unit and a worm gear operatively connected thereto are arranged, which are driven by an electric motor. A force can be applied to a brake piston for braking via the spindle drive unit. A second module variant, in addition to the first module variant, includes a planetary gear, which is also arranged in the brake caliper housing, between the worm gear and the spindle drive unit.

### CROSS REFERENCE

The present application claims the benefit under 35 U.S.C. § 119 of German Patent Application No. DE 10 2024 201 722.1 filed on Feb. 26, 2024, which is expressly incorporated herein by reference in its entirety.

### FIELD

The present invention relates to an electromechanical brake for a motor vehicle and to a motor vehicle having such an electromechanical brake.

### BACKGROUND INFORMATION

The service brake is usually a brake that uses brake fluid to press a brake piston together with a brake pad onto a brake disk in order to brake the vehicle. The parking brake, on the other hand, is designed as an electromechanical brake. As part of the increasing electrification of motor vehicle components, the service brake is also intended to be designed as an electromechanical brake, thereby making it possible to dispense with brake fluid and the associated complex valve and line structure. Such an electromechanical brake could also significantly reduce maintenance requirements.

European Patent No. EP 1 030 979 B1 describes an electromechanical braking device for braking a motor vehicle wheel. The braking device comprises a brake caliper in which an electric motor is arranged. The electric motor drives a spindle drive unit, via which brake pads arranged on a brake clamp of the brake caliper can be applied to a brake disk for braking.

Germany Patent Application No. DE 10 2018 211 443 A1 describes a pressure generating device for a braking system of a vehicle.

U.S. Patent Application Publication No. US 2019/0003535 A1 describes a clamp for a brake unit for overlapping the outer side of a tensioning disk of a cabin, having an electric motor driving a rotary shaft, a first endless screw that is engaged with a first primary gear, and a second endless screw that is engaged with a second primary gear.

An object of the present invention is to provide an electromechanical brake for a motor vehicle that can be used for different axial forces with little modification effort and in an economical manner.

The object may be achieved by an electromechanical brake for a motor vehicle with certain features of the present invention. Preferred embodiments of the present invention are disclosed herein.

### SUMMARY

The present invention provides an electromechanical brake for a motor vehicle. The electromechanical brake has a modular design, and a first module variant comprises a brake clamp and a brake caliper housing connected to the brake clamp, in which housing a spindle drive unit and a worm gear operatively connected thereto are arranged, which are driven by an electric motor. A force can be applied to a brake piston for braking via the spindle drive unit, wherein the second module variant, in addition to the first module variant, comprises a planetary gear, which is also arranged in the brake caliper housing, between the worm gear and the spindle drive unit.

A module variant is understood to mean a structural unit that is constructed from different components that are comparable with one another in different variants. The different variants are constructed in a comparable way to one another. Different components can be identical to one another even in different variants. This has the advantage that such module variants are designed in the same way, which reduces the design effort and allows them to be manufactured on the same production line. As a result, the production of such an electromechanical brake is more economical.

According to an example embodiment of the present invention, the second module variant comprises a planetary gear, via which a transmission ratio between the worm gear and the spindle drive unit is modified in comparison to the first module variant. As a result, it is possible to increase the braking force on the brake piston. Despite using substantially identical components, two different module variants can be provided via the planetary gear, which can be used for different braking forces. With an electromechanical brake constructed in this way, two different module variants can be provided in an economical manner.

In a preferred embodiment of the present invention, a worm wheel of the worm gear has the same diameter in both module variants. Although the two variants are intended to generate a different braking force, the diameter of the worm wheel can remain the same. As a result, the diameter of the brake caliper housing does not change despite a higher braking force. The electromechanical brake can thus be designed compactly in both variants.

In a further preferred embodiment of the present invention, the electric motor is the same in both module variants. Thus, an additional electric motor does not need to be designed for the different module variants. In addition, it is not necessary to keep two different variants of electric motors in stock. Due to the use of the same electric motor, it is thus possible in an economical manner to provide two different module variants with different braking forces.

Preferably, the planet wheels are formed from a plastics material. Planet wheels made of a plastics material have the advantage that they are significantly lighter than planet wheels made of metal. In addition, material costs are reduced when using plastics material. Such planet wheels made of plastics material are also easy to produce by injection molding. Such an electromechanical brake is not only lighter, but also more economical to produce.

In an advantageous further development of the present invention, the planetary gear comprises a hollow sun wheel, over which a spindle of the spindle drive unit is passed. As a result, it is possible to arrange a parking brake at one axial end. In addition, the worm wheel can be mounted on the spindle. Thus, no additional components need to be provided in order to mount the worm wheel. Due to the hollow sun wheel, a large number of planet wheels can be used, so that the load is distributed over many tooth engagements. Accordingly, it is possible to select a more cost-effective material, such as plastics, for each planet wheel.

According to an example embodiment of the present invention, advantageously, a parking brake is arranged at one end of the spindle, via which the spindle can be locked in a braked position. Due to the parking brake, the brake can be locked during a parking maneuver. Due to the formation of the parking brake at one end of the spindle, instead of the worm wheel, for example, no force acts on the planetary gear during the parking process. Rather, the parking brake acts directly on the spindle nut, which is formed as a brake piston. As a result, the play between the parking brake and the brake piston is reduced, so that after the parking brake is applied, the existing play does not lead to a reduction in the parking brake force. Due to the force-free planetary gear, creeping is prevented, in particular in planet wheels made of plastics.

In a further advantageous example embodiment of the present invention, the spindle drive unit is a ball screw drive. In a ball screw drive, balls are arranged between the spindle and the spindle nut, via which the axial force is transmitted. Due to the balls, a ball screw drive exhibits low friction despite a higher number of thread turns. Due to the lower friction, an electric motor can have smaller dimensions. A ball screw drive also has the advantage that it is suitable for higher loads.

According to an expedient embodiment of the present invention, the second module variant comprises a longer spindle. In particular, the longer spindle comprises a longer engagement region with the spindle nut. As a result, the force is distributed over more thread turns, so that a higher axial force can be transmitted with the spindle drive unit. In addition, the spindle is extended in order to be able to accommodate the planetary gear in the second module variant.

In addition, the present invention provides a motor vehicle that comprises such an electromechanical brake. A motor vehicle of this kind has the advantages and properties described above.

Exemplary embodiments of the present invention are illustrated in the figures and explained in more detail in the following description.

### BRIEF DESCRIPTION OF THE DRAWINGS

FIG. 1 is a sectional view of an exemplary embodiment of a first module variant of the electromechanical brake, and

FIG. 2 is a sectional view of an exemplary embodiment of a second module variant of the electromechanical brake.

### DETAILED DESCRIPTION OF EXAMPLE EMBODIMENTS

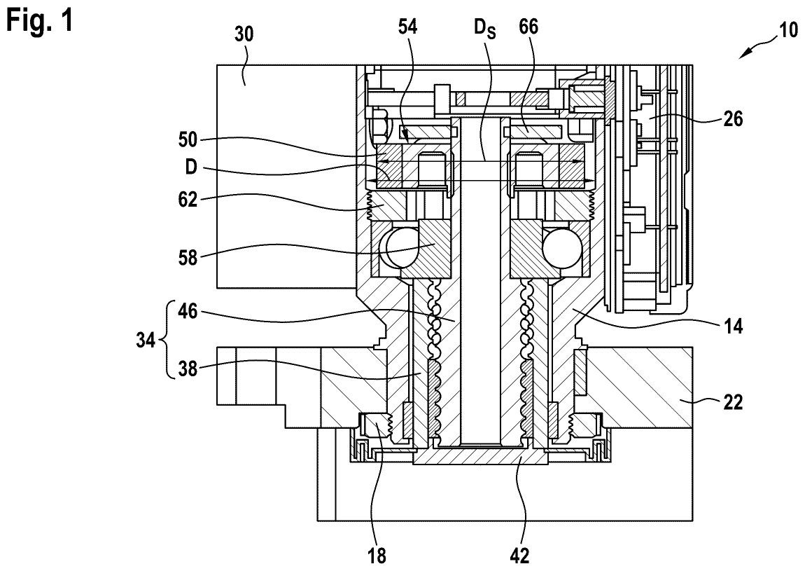

FIG. 1 is a sectional view of an exemplary embodiment of a first module variant of the electromechanical brake 10. The electromechanical brake 10 according to the first module variant comprises a brake caliper housing 14, which is connected to a brake clamp 22 of the electromechanical brake 10 via connecting means 18. A control unit 26 and an electric motor 30 are additionally arranged on the brake caliper housing 14. The electric motor 30 can be controlled via the control unit 26.

A spindle drive unit 34 is arranged in the brake caliper housing 14, via which a pressure plate 42 arranged on a spindle nut 38 of the spindle drive unit 34 is axially displaceable. In the exemplary embodiment shown, the spindle nut 38 is thus also simultaneously the brake piston of the electromechanical brake 10. A worm wheel 50 of a worm gear 54 is non-rotatably mounted on a spindle 46 of the spindle drive unit 34 and is driven by the electric motor 30. The spindle 46 is rotatably mounted in the brake caliper housing 14 via an angular contact ball bearing 58. The angular contact ball bearing 58 rests on a retaining plate 62 introduced into the brake caliper housing 14, via which plate axial forces of the angular contact ball bearing 58 are absorbed. In the exemplary embodiment shown here, the spindle drive unit 34 is formed as a ball screw drive.

A parking brake 66 is arranged at one axial end of the spindle 46, via which the spindle 46 can be locked. The parking brake 66 is provided downstream of the worm wheel 50 on the spindle 46.

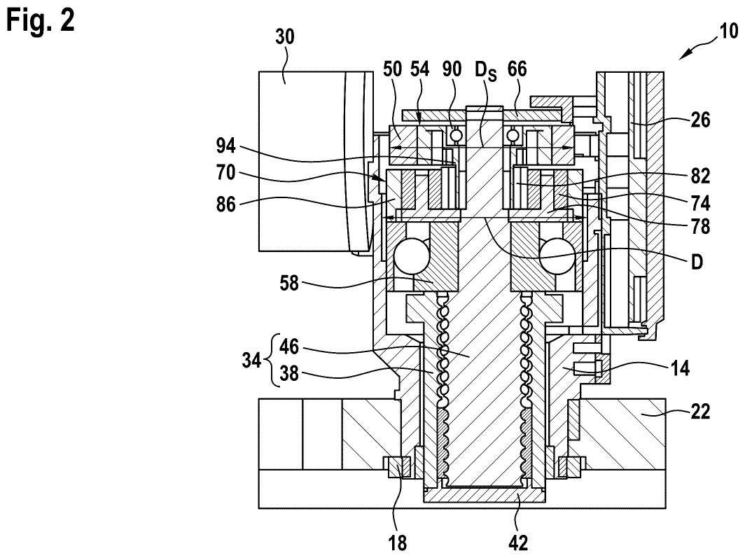

FIG. 2 is a sectional view of an exemplary embodiment of a second module variant of the electromechanical brake 10. This module variant differs from the module variant shown in FIG. 1 in that a planetary gear 70 is arranged between the angular contact ball bearing 58 and the worm wheel 50, instead of the retaining plate 62. By means of the second module variant, it is possible to apply a higher braking force. Both variants comprise the same electric motor 30. Moreover, an inner diameter D of the brake caliper housing 14, as well as a diameter Ds for the worm wheel 50, is the same for both module variants.

However, in order to be able to absorb the higher braking forces, a spindle drive unit 34 is provided with which the engaging thread turns between the spindle 46 and the spindle nut 38 are increased. Accordingly, the spindle 46 and the spindle nut 38 are formed to be longer compared to the first module variant. The angular contact ball bearing 58 is selected in the same way, such that it can accommodate a higher axial load.

The planetary gear 70 is formed from planet wheels 74, which are arranged on a planet carrier 78, wherein the planet wheels 74 orbit a central sun wheel 82. The planet carrier 78 is firmly connected to the spindle 46, so that the spindle 46 is driven by the rotation of the planet carrier 78. The planet wheels 74 and the sun wheel 82 are surrounded by a ring wheel 86. The planet wheels 74 are in meshing engagement with this ring wheel 86. In the exemplary embodiment shown, the sun wheel 82 is hollow, and therefore the spindle 46 passes through the sun wheel 82.

In contrast to the first module variant, the worm wheel 50 is not firmly connected to the spindle 46. A bearing 90 is arranged between the spindle 46 and the worm wheel 50, via which bearing the worm wheel 50 is rotatably mounted on the spindle 46. The worm wheel 50 forms an axial extension 94, which extends between the sun wheel 82 and the spindle 46. The axial extension 94 is connected to the sun wheel 82 for conjoint rotation, and therefore the sun wheel 82 is driven via the worm wheel 50.

A higher braking force can be applied via the planetary gear 70, despite the same electric motor 30. With the exception of the planetary gear 70, both module variants comprise comparable components, and therefore both module variants can be produced on the same production line. Thus, a more economical production of both module variants is possible.

What is claimed is:

1. An electromechanical brake for a motor vehicle, wherein the electromechanical brake has a modular design, comprising:
a first module variant including a brake clamp and a brake caliper housing connected to the brake clamp, a spindle drive unit and a worm gear operatively connected to the spindle drive being arranged in the housing, and are driven by an electric motor, wherein a force can be applied to a brake piston for braking via the spindle drive unit; and
a second module variant including, in addition to the first module variant, a planetary gear, which is also arranged in the brake caliper housing, between the worm gear and the spindle drive unit.

2. The electromechanical brake according to claim 1, wherein a worm wheel of the worm gear has the same diameter in both the first and the second module variants.

3. The electromechanical brake according to claim 1, wherein the electric motor is the same in both module variants.

4. The electromechanical brake according to claim 1, wherein the planet wheels are formed from a plastics material.

5. The electromechanical brake according to claim 1, wherein the planetary gear includes a hollow sun wheel, over which a spindle of the spindle drive unit is passed.

6. The electromechanical brake according to claim 5, wherein a parking brake is arranged at one end of the spindle, via which the spindle can be locked in a braked position.

7. The electromechanical brake according to claim 1, wherein the spindle drive unit is a ball screw drive.

8. The electromechanical brake according to claim 1, wherein the spindle drive includes a spindle, wherein the second module variant includes a longer spindle than the first module variant.

9. A motor vehicle, comprising:
an electromechanical brake having a modular design, including a module selected from the following:
a first module variant including a brake clamp and a brake caliper housing connected to the brake clamp, a spindle drive unit and a worm gear operatively connected to the spindle drive being arranged in the housing, and are driven by an electric motor, wherein a force can be applied to a brake piston for braking via the spindle drive unit; and
a second module variant including, in addition to the first module variant, a planetary gear, which is also arranged in the brake caliper housing, between the worm gear and the spindle drive unit.
